(19) United States
(12) Patent Application Publication
(10) Pub. No.: US 2006/0275582 A1
(43) Pub. Date: Dec. 7, 2006

(54) Wooden board having outstanding outer appearance

(76) Inventor: Ming-Shan Yang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/144,242

(22) Filed: Jun. 6, 2005

(51) Int. Cl. B32B 3/00

(52) U.S. Cl. 428/156

(57) ABSTRACT

A wooden board includes a board body having a surface formed with a plurality of annual ring stripes. The annual ring stripes of the board body form a plurality of protruded portions and a plurality of recessed portions on the surface of the board body. Thus, the board body has a plurality of annual ring stripes forming a plurality of protruded portions and a plurality of recessed portions, so that the wooden board has an outstanding outer appearance.

### BACKGROUND OF THE INVENTION

1. Field of the Invention

The present invention relates to a wooden board, and more particularly to a wooden board for a furniture, an architecture design or the like.

2. Description of the Related Art

A conventional wooden board in accordance with the prior art shown in FIG. 6 comprises a board body 10 having a surface formed with a plurality of wooden stripes 11 arranged in a regular manner. However, the wooden stripes 11 are arranged on the surface of the board body 10 in a regular manner, so that the board body 10 has a monotonous outer appearance, thereby decreasing the aesthetic quality of the conventional wooden board.

### SUMMARY OF THE INVENTION

The primary objective of the present invention is to provide a wooden board having an enhanced outer appearance.

Another objective of the present invention is to provide a wooden board, wherein the board body has a plurality of annual ring stripes forming a plurality of protruded portions and a plurality of recessed portions, so that the wooden board has an outstanding outer appearance.

A further objective of the present invention is to provide a wooden board, wherein the board body has a compact surface to provide a wear-resistance effect, so that the wooden board is not worn out during a long-term utilization, thereby enhancing the lifetime of the wooden board.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wooden board in accordance with the preferred embodiment of the present invention;

FIG. 2 is a top plan view of the wooden board as shown in FIG. 1;

FIG. 3 is a side plan view of the wooden board as shown in FIG. 1;

FIG. 4 is a perspective view showing a process for forming the wooden board as shown in FIG. 1;

FIG. 5 is a perspective view of a wooden board in accordance with another preferred embodiment of the present invention; and

FIG. 6 is a perspective view of a conventional wooden board in accordance with the prior art.

### DETAILED DESCRIPTION OF THE INVENTION

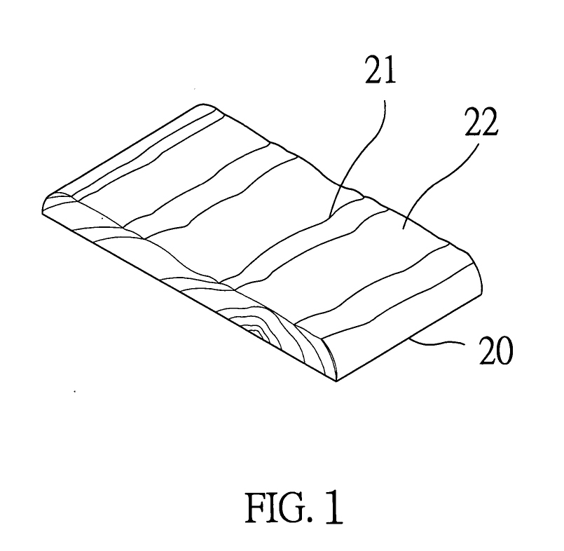

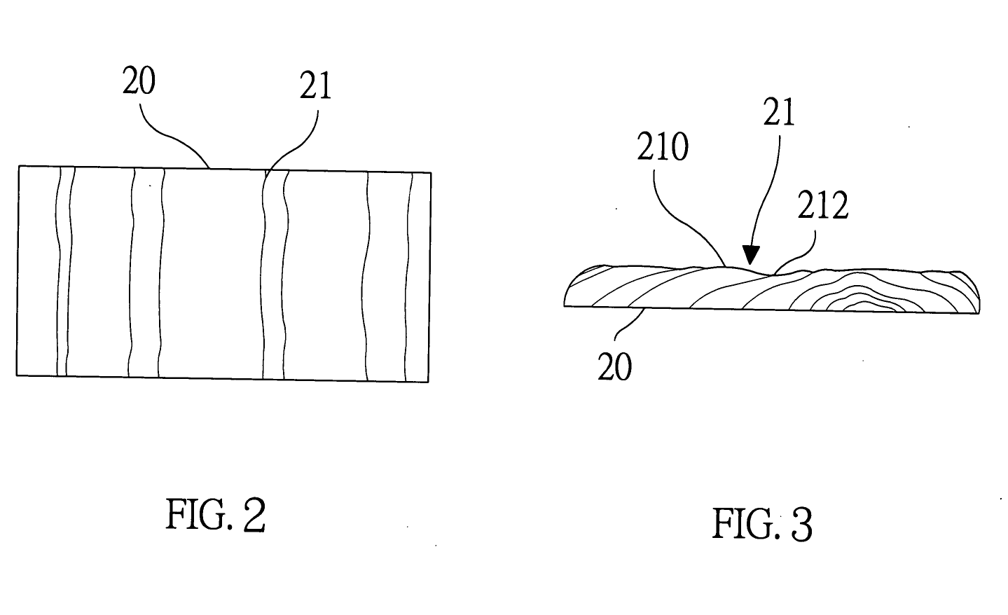

Referring to the drawings and initially to FIGS. 1-3, a wooden board in accordance with the preferred embodiment of the present invention comprises a board body 20 having a corrugated surface 22. The corrugated surface 22 of the board body 20 has a plurality of annual ring stripes 21 arranged in an irregular manner. The annual ring stripes 21 of the board body 20 are extended in a longitudinal direction of the board body 20. The annual ring stripes 21 of the board body 20 form a plurality of protruded portions 210 and a plurality of recessed portions 212 on the corrugated surface 22 of the board body 20. The protruded portions 210 and the recessed portions 212 of the annual ring stripes 21 of the board body 20 are arranged in a staggered manner.

As shown in FIG. 3, the protruded portions 210 and the recessed portions 212 of the annual ring stripes 21 of the board body 20 have different depths and positions, thereby enhancing the aesthetic quality of the board body 20.

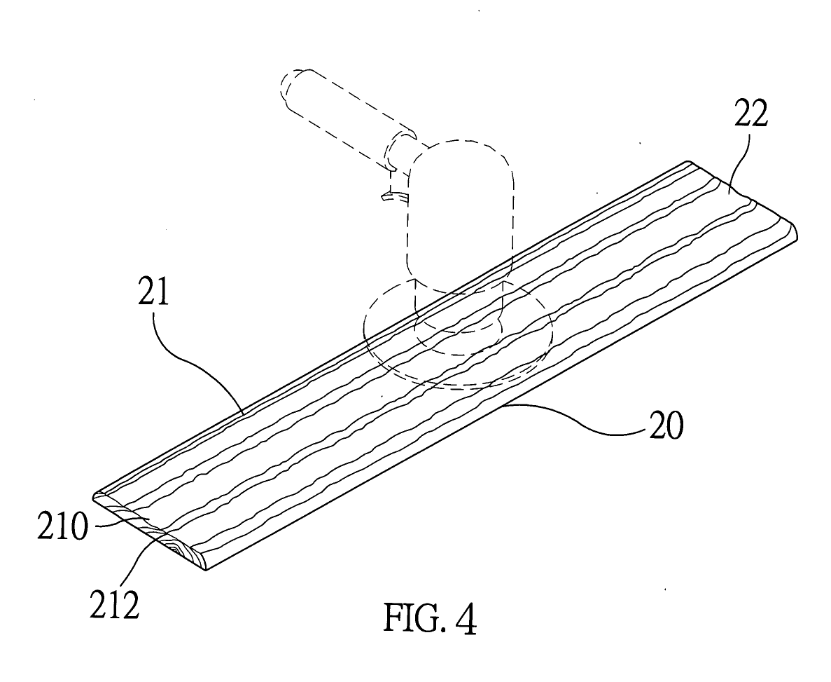

As shown in FIG. 4, the annual ring stripes 21 are formed on the surface of the board body 20 in an abrasive polishing process. In practice, the annual rings of the wooden board are formed by the change of the ambient temperature. When the ambient temperature is relatively higher in the summer, the annual rings of the wooden board have wider and looser stripes with lighter colors, and when the ambient temperature is relatively lower in the winter, the annual rings of the wooden board have narrower and compact stripes with deeper colors. Thus, when the surface of the board body 20 is finished during the abrasive polishing process, the peripheral wall of the looser annual rings of the wooden board are cut to form recessed portions, and the peripheral wall of the compact annual rings of the wooden board are left to form protruded portions, so that the annual ring stripes 21 of the board body 20 form a plurality of protruded portions 210 and a plurality of recessed portions 212 on the surface 22 of the board body 20. In addition, the board body 20 has a compact surface.

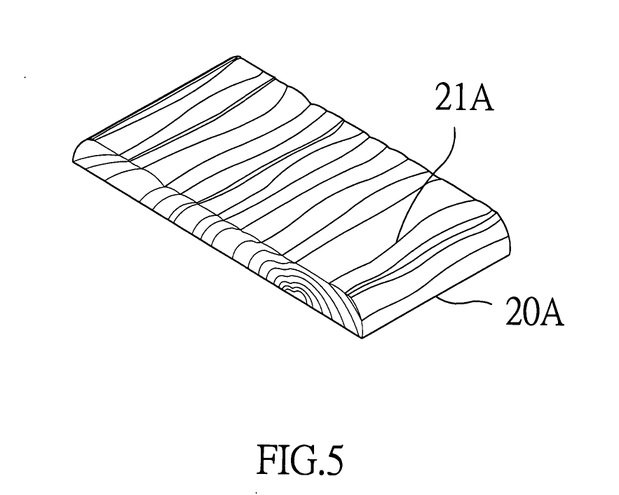

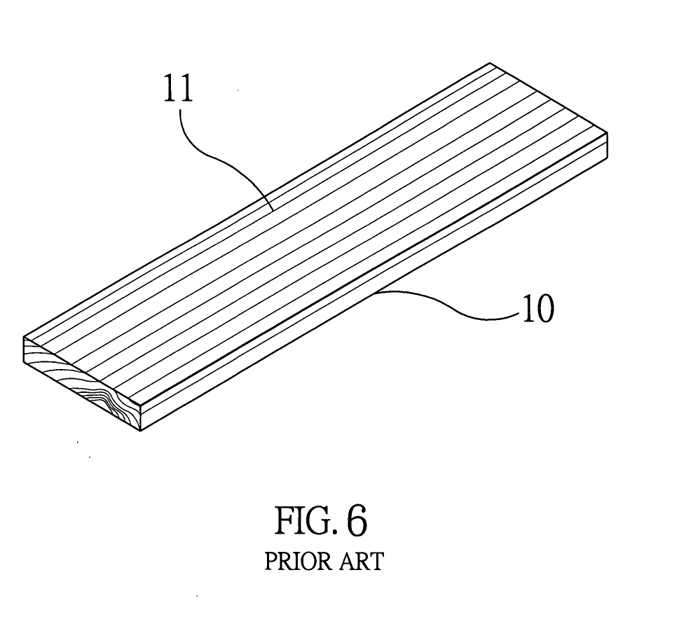

As shown in FIG. 5, the annual ring stripes 21A of the board body 20A have different arrangement, thereby enhancing the aesthetic quality of the board body 20A.

Accordingly, the board body 20 has a plurality of annual ring stripes 21 forming a plurality of protruded portions 210 and a plurality of recessed portions 212, so that the wooden board has an outstanding outer appearance. In addition, the board body 20 has a compact surface to provide a wear-resistance effect, so that the wooden board is not worn out during a long-term utilization, thereby enhancing the lifetime of the wooden board.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wooden board, comprising:
a board body having a surface formed with a plurality of annual ring stripes, wherein:
the annual ring stripes of the board body form a plurality of protruded portions and a plurality of recessed portions on the surface of the board body.

2. The wooden board in accordance with claim 1, wherein the surface of the board body has a corrugated shape.

3. The wooden board in accordance with claim 1, wherein the annual ring stripes of the board body are arranged in an irregular manner.

4. The wooden board in accordance with claim 1, wherein the annual ring stripes of the board body are extended in a longitudinal direction of the board body.

5. The wooden board in accordance with claim 1, wherein the protruded portions and the recessed portions of the annual ring stripes of the board body are arranged in a staggered manner.

6. The wooden board in accordance with claim 1, wherein the protruded portions and the recessed portions of the annual ring stripes of the board body have different depths.

7. The wooden board in accordance with claim 1, wherein the protruded portions and the recessed portions of the annual ring stripes of the board body have different positions.

8. The wooden board in accordance with claim 1, wherein the annual ring stripes are formed on the surface of the board body in an abrasive polishing process.

9. The wooden board in accordance with claim 1, wherein the board body has a compact surface.

10. The wooden board in accordance with claim 1, wherein the annual ring stripes of the board body have different arrangement.
